(19) United States
(12) Patent Application Publication
(10) Pub. No.: US 2003/0146191 A1
(43) Pub. Date: Aug. 7, 2003

(54) ETCHING METHOD FOR NICKEL-VANADIUM ALLOY

(76) Inventors: Ho-Ming Tong, Taipei (TW); Chun-Chi Lee, Kaohsiung (TW); Jen-Kuang Fang, Pingtung Hsien (TW); Min-Lung Huang, Kaohsiung (TW); Jau-Shoung Chen, Hsinchu Hsien (TW); Ching-Huei Su, Kaohsiung (TW); Chao-Fu Weng, Tainan (TW); Yung-Chi Lee, Kaohsiung (TW); Yu-Chen Chou, Kaohsiung (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/248,335

(22) Filed: Jan. 10, 2003

(30) Foreign Application Priority Data
Feb. 7, 2002 (TW) 91102171

(51) Int. Cl. C03C 25/68; C23F 1/00

(52) U.S. Cl. 216/100; 216/108

(57) ABSTRACT

A method for etching a nickel-vanadium alloy is described. The etching of the nickel-vanadium alloy is conducted using an etchant that comprises sulfuric acid. Further, the etching rate of the nickel-vanadium alloy is controlled based on the electrolytic reaction between the etchant and the nickel-vanadium alloy thin film.

### CROSS REFERENCE TO RELATED APPLICATIONS

This application claims the priority benefit of Taiwan application serial no. 911 021 71, filed Feb. 7, 2002.

### BACKGROUND OF INVENTION

1. Field of the Invention

The present invention relates to a method for etching a nickel-vanadium alloy. More particularly, the present invention relates to a method for etching a nickel-vanadium alloy, wherein sulfuric acid is used as an etchant and a voltage or current is applied to control the etching rate.

2. Background of the Invention

Two types of etching techniques are broadly used in the semiconductor processing, wherein one type of the etching techniques is wet etching and the other is drying etching. Wet etching basically relies on a chemical reaction to perform the etching of a thin film, while dry etching is based on a physical phenomenon for the film etching. Wet etching is the originally used etching technique, wherein the removal of the thin film results from a chemical reaction between the thin film and the etchant. On the other hand, etching plasma is the tool used in dry etching, wherein the thin film is etched resulting from an ion bombardment from the plasma. Wet etching is an anisotropic type of etching, while drying etching is an isotropic type of etching.

The chemical reaction in wet etching is between the etchant and the thin film. The reactant in the etchant diffuses to the surface of the thin film, and reacts with the molecules on the surface of the thin film to generate a product. The generated product then discharges to the etchant by diffusion to complete the thin-film removal process. However, to properly control the wet eching reaction, there are several major parameters that need to be considered, such as, the etchant concentration, the etching reaction time, the etching reaction temperature and the method for mixing the etchant, etc. Normally, when the etchant concentration or the temperature is higher, the thin film-etching rate is faster. Further, when the film is thick, the etching reaction time is longer. Moreover, with an appropriate mixing method, the reaction between the reactant and the thin film enhances due to the increase of fluid convention resulting from the mixing action, rather than completely relying on diffusion.

In U.S. Pat. No. 5,508,229, performing a one-step etching method to define an under ball metallurgy (UBM) on a substrate material is disclosed, wherein the under ball metallurgy is a three-layered structure of aluminum/nickel-vanadium alloy/copper. Subsequent to the formation of solder bumps, the aluminum, nickel-vanadium alloy and copper outside the soldered area are simultaneously removed by an etchant that comprises phosphoric acid, deionized water, acetic acid and hydrogen peroxide. The concentrations of these components in the etchant disclosed in U.S. Pat. No. 5,508,229 are as follows: phorphoric acid is about 1% to 25%, deionized water is about 63% to 98%, acetic acid is about 1% to 10% and hydrogen peroxide is about 0.1% to 2%. Further, the etching reaction temperature is about 70 degrees Celsius, while the etching reaction time is about 90 seconds to 600 seconds.

However, based on the disclosure in U.S. Pat. No. 5,508,229, it is difficult to determine how etching concentration, etching reaction time and etching reaction temperature control and adjust the etching rate. Further, if the etching rate is controlled by the above parameters, the range for the etching rate is very limited.

### SUMMARY OF INVENTION

Accordingly, the present invention provides a method for etching a nickel-vanadium alloy, wherein sulfuric acid is used as an etchant.

The present invention provides a method for etching a nickel-vanadium alloy, wherein electric current or voltage is applied to control the electrolytic reaction between the etchant and the nickel-vanadium alloy. The etching rate of the nickel-vanadium alloy is increased by the electrolytic reaction.

In accordance with the present invention, a method for etching a nickel-vanadium alloy is provided, wherein a container comprising an etchant therein is provided. The etchant is formed with, for example, sulfuric acid and deionized water, wherein the concentration of the sulfuric acid is about 0.5% to 98%.

According to the present invention, the etching rate for a nickel-vanadium alloy is enhanced. The method of the present invention provides an electrolytic tank, which contains an etching solution. The etching solution is formed with, for example, sulfuric acid and deionized water. The concentration of sulfuric acid is between 0.5% to 98%. A cathode and an anode are further provided and placed in the etchant. A material for the cathode is, for example, platinum/titanium (Pt/Ti) or titanium (Ti), while the nickel-vanadium alloy serves as the electrolytic anode. The etching rate of the nickel-vanadium alloy on the substrate material is controlled by the electrolytic reaction.

During the etching of the nickel-vanadium alloy in the present invention, the concentration of sulfuric acid is controlled between 0.5% to 98% and the reaction temperature is between room temperature to about 80 degrees Celsius. Under such an etching condition, a nickel-vanadium alloy is efficiently etched.

In the present invention, the sulfuric acid concentration can also be about 5% to 80% and is preferably controlled to about 10%. During the etching of the nickel-vanadium alloy, a fixed current electrolytic method is employed to etch the nickel-vanadium alloy, wherein the fixed current is about 0.0005A/cm² to about 0.5A/cm².

Further, in accordance of the present invention, step current, pulse current or fixed current can also be used to perform the nickel-vanadium alloy electrolysis.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram illustrating the etching of a nickel-vanadium alloy using sulfuric acid as an etchant according to one aspect of the present invention; and

FIG. 2 is a schematic diagram illustrating the control of the nickel-vanadium etching rate by an electrolytic reaction according to one aspect of the present invention.

### DETAILED DESCRIPTION

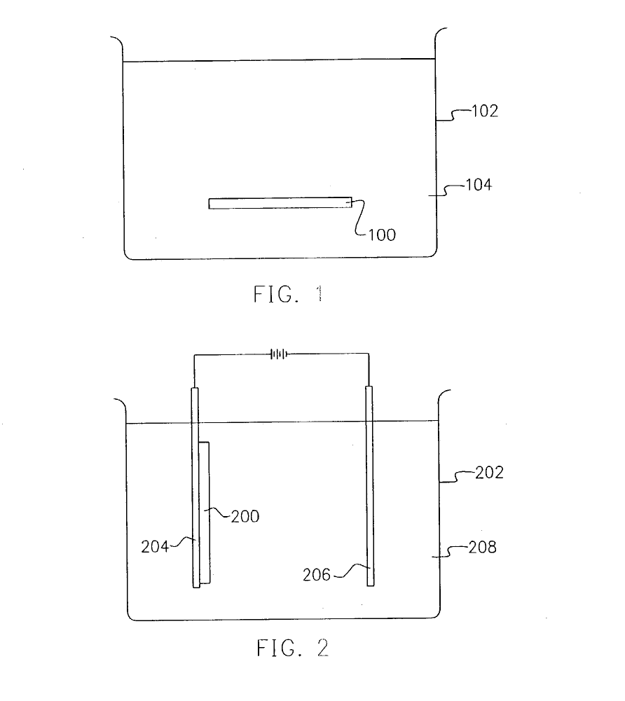

Referring to FIG. 1, FIG. 1 is a schematic diagram illustrating the etching of a nickel-vanadium alloy using sulfuric acid as an etchant according to one aspect of the present invention. To perform an etching on a nickel-vanadium alloy, a container 102 is first provided, wherein an etchant 104 is placed in the container 102. The etchant 104, for example, is formed with sulfuric acid and deionized water, wherein the concentration of sulfuric acid is about 0.5% to about 98%.

The etchant 104 for etching the nickel-vanadium alloy of the present invention comprises sulfuric acid. Diluting the sulfuric acid with deionzied water is easily accomplished and is simpler than the conventional approach using phosphoric acid, deionized water, acetic acid and hydrogen peroxide as an etchant. Further, the etchant 104 of the present invention is favorably compatible with the etching characteristics of the nickel-vanadium alloy, such as, etching rate, etching selectivity ratio, etc.

Referring to FIG. 2, FIG. 2 is a schematic diagram illustrating the control of the nickel-vanadium etching rate by an electrolytic reaction according to one aspect of the present invention. During the etching of a nickel-vanadium alloy on a substrate material 200, an electrolytic tank 202 is provided, wherein an etchant 208 is placed inside the electrolytic tank 202. The etchant 208 is formed with sulfuric acid and deionized water, wherein the sulfuric acid concentration is about 0.5% to about 98%, while the concentration of the deionized water is between about 2% to about 99.5%.

Still referring to FIG. 2, an anode 204 and a cathode 206 are provided. The anode 204 and the cathode 206 are submerged in the etchant 208. The anode is formed with a material including platinum/titanium or titanium. The substrate material 200 that comprises the nickel-vanadium alloy is also submerged in the etchant 208 and is disposed on the anode 204. The nickel-vanadium alloy is thus equivalent to an electrolytic anode. The electrolytic reaction conducted in the electrolytic tank 202 is then used to control the etching rate of the nickel-vanadium alloy on the substrate material 200.

In this aspect of the present invention, the concentration of the sulfuric acid is controlled to about 0.5% to 98% and the reaction temperature is between room temperature to about 80 degrees Celsius. Under such an etching condition, the nickel-vanadium alloy is etched.

In this aspect of the present invention, the sulfuric acid concentration is between about 5% to about 80%, and is preferably controlled to about 10%. The electrolytic method used in etching the nickel-vanadium alloy includes fixed current electrolysis, wherein the fixed current is between about 0.005A/cm² and about 0.5A/cm². The present invention can further employ step current, pulse current or fixed voltage electrolysis for etching the nickel-vanadium alloy.

However, the above etching condition, regardless of whether it is temperature, sulfuric acid concentration or the electrolytic condition (condition for fixed current electrolysis, pulse current electrolysis, step current electrolysis, fixed voltage electrolysis), can be changed depending on the specification of the manufacturing process.

Since the etchant selected for the present invention comprises sulfuric acid and deionized water, the diluted sulfuric acid in the electrolytic tank 202 electrolyzes the nickel-vanadium alloy, which is then discharged into the etchant 208. The etching rate of the nickel-vanadium alloy is thereby enhanced. Using phosphoric acid, acetic acid, hydrogen peroxide and deionized water mixture as the etchant in the prior art, the etching rate can not be improved by an electrolytic reaction.

The method for etching a nickel-vanadium alloy of the present invention is applicable to any process wherein a nickel-vanadium alloy needs to be etched, for example, the manufacturing of an under ball metallurgy in a bumping process or the patterning of a nickel-vanadium alloy layer on a substrate material.

In accordance to the present invention, the method for etching a nickel-vanadium alloy of the present invention, in which a major component of the etchant is sulfuric acid and deionized water, provides a favorable etching effect on the nickel-vanadium alloy.

Further, the etching method of a nickel vanadium alloy of the present invention can rely on the etchant and the electrolytic reaction between the etchant and the nickel-vanadium alloy to control the etching rate of the nickel-vanadium alloy.

Moreover, using the etching method of the present invention to remove the nickel-vanadium alloy of an under ball metallurgy during a bumping process, the solder bumps are prevented from being damaged.

Further, the required cost for the nickel-vanadium alloy etching method of the present invention is low.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. An etching method for a nickel-vanadium alloy, comprising:
providing an etchant, which comprises at least sulfuric acid; and
using the etchant to perform an etching on the nickel-vanadium alloy.

2. An etching method for a nickel-vanadium alloy, comprising:
providing an etchant that comprises sulfuric acid and deionized water; and
using the etchant to etch the nickel-vanadium alloy.

3. The method of claim 2, wherein a concentration of the sulfuric acid is about 0.5% to about 98%.

4. The method of claim 2, wherein a concentration of the deionized water is about 2% to about 99.5%.

5. An etching method for a nickel-vanadium alloy, comprising:
providing an electrolytic tank, wherein an etching solution is placed in the electrolytic tank,
and the etching solution comprises sulfuric acid and deionized water;
providing an anode and a cathode;
placing a substrate material having a nickel-vanadium alloy thereon on the anode; and
controlling an etching rate of the nickel-vanadium alloy by an electrolytic reaction.

6. The method of claim 5, wherein a concentration of the sulfuric acid is about 0.5% to about 98%.

7. The method of claim 5, wherein a concentration of the deionized water is about 2% to about 99.5%.

8. The method of claim 5, wherein a material for the cathode includes platinum/titanium.

9. The method of claim 5, wherein a material for the cathode includes titanium.

10. The method of claim 5, wherein the electrolytic reaction includes generating a fixed current to electrolyze the nickel-vanadium alloy.

11. The method of claim 10, wherein the fixed current is about 0.005A/cm² to about 0.5A/cm².

12. The method of claim 5, wherein the electrolytic reaction includes generating a step current to electrolyze the nickel-vanadium alloy.

13. The method of claim 5, wherein the electrolytic reaction includes generating a pulse current to electrolyze the nickel-vanadium alloy.

14. The method of claim 5, wherein the electrolytic reaction includes providing a voltage between the anode and cathode to electrolyze the nickel-vanadium alloy.
